(19) United States
(12) Patent Application Publication
(10) Pub. No.: US 2006/0040710 A1
(43) Pub. Date: Feb. 23, 2006

(54) System and method of providing personally tailored communications

(75) Inventors: Johannes Ruetschi, Boca Raton, FL (US); Joseph LoBuono, Delray Beach, FL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Information and Communication Networks, Inc.

(21) Appl. No.: 10/919,619

(22) Filed: Aug. 17, 2004

(51) Int. Cl. H04B 1/38

(52) U.S. Cl. 455/566

(57) ABSTRACT

A communications system, service provider infrastructure, method and program product for providing personally tailored communications. System communications devices are identified with corresponding system subscribers. System subscribers can provide/select information for display at individual devices, e.g., cell phone displays. Communications are monitored at service provider infrastructure and user specific information is passed to selected communications devices. Individually tailored information is displayed for each specific user at corresponding communications devices, e.g., as an advertisement in a banner on the device display.

### BACKGROUND OF THE INVENTION

1. Field of the Invention

The present invention is related to communications and more particularly, to providing individually tailored communications to service subscribers.

2. Background Description

Technology convergence has blurred the lines between individual interpersonal communications, entertainment and business transactions. Service providers, such as Verizon Communications, have increased their range of services providing, for example, wireless phone and Internet services in addition to more traditional landline phone services. Cell phones with Internet capability allow users to surf the web through the cell phone web browser. Conversely, Internet based call services including local and long distance are available (e.g., from Vonage Holdings Corp. or from major cable service companies) that may obviate the need for a landline based phone service. Nearly every successful business concern maintains a web presence to freely distribute product information to current and potential customers.

Additionally, a much greater variety of content and in particular, personal and business information, is available from each of these services. Streaming video is available for download over the Internet. Web sites distribute cookies that collect user information to facilitate on-line sales, e.g., suggest products of interest based on previous web site visits. Account maintenance capabilities, e.g., on-line banking, allow users to pay bills, make purchases or transfer money, without ever making a written transaction. Thus, these approaches are focused on getting information to potential clients/customers without subjecting the potential recipient to information overload, i.e., providing so much information as to make the information being provided useless.

Thus, there is a need for tightly tailoring information provided to communications service users to the preferences, needs and interests of the particular user.

### SUMMARY OF THE INVENTION

It is a purpose of the invention to tightly tailor information provided to communications service users to the needs of the particular user;

It is another purpose of the invention to minimize extraneous information provided to communications service users;

It is yet another purpose of the invention to pass information related to a particular user to communications devices associated with that user;

It is yet another purpose of the invention to pass information related to a particular communications service user to communications devices associated with that user while minimizing extraneous information provided to all communications service users.

The present invention relates to a communications system, service provider infrastructure, method and program product for providing personally tailored communications. System communications devices are identified with corresponding system subscribers. System subscribers can provide/select information for display at individual devices, e.g., cell phone displays. Communications are monitored at service provider infrastructure and user specific information is passed to selected communications devices. Individually tailored information is displayed for each specific user at corresponding communications devices, e.g., as an advertisement in a banner on the device display.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an example of a preferred embodiment service communications network that provides personalized information, individually tailored to the particular subscriber;

FIG. 2 shows an example flow diagram example of a preferred embodiment system wherein personalized information is individually tailored and distributed to communications devices for service subscribers.

### DESCRIPTION OF PREFERRED EMBODIMENTS

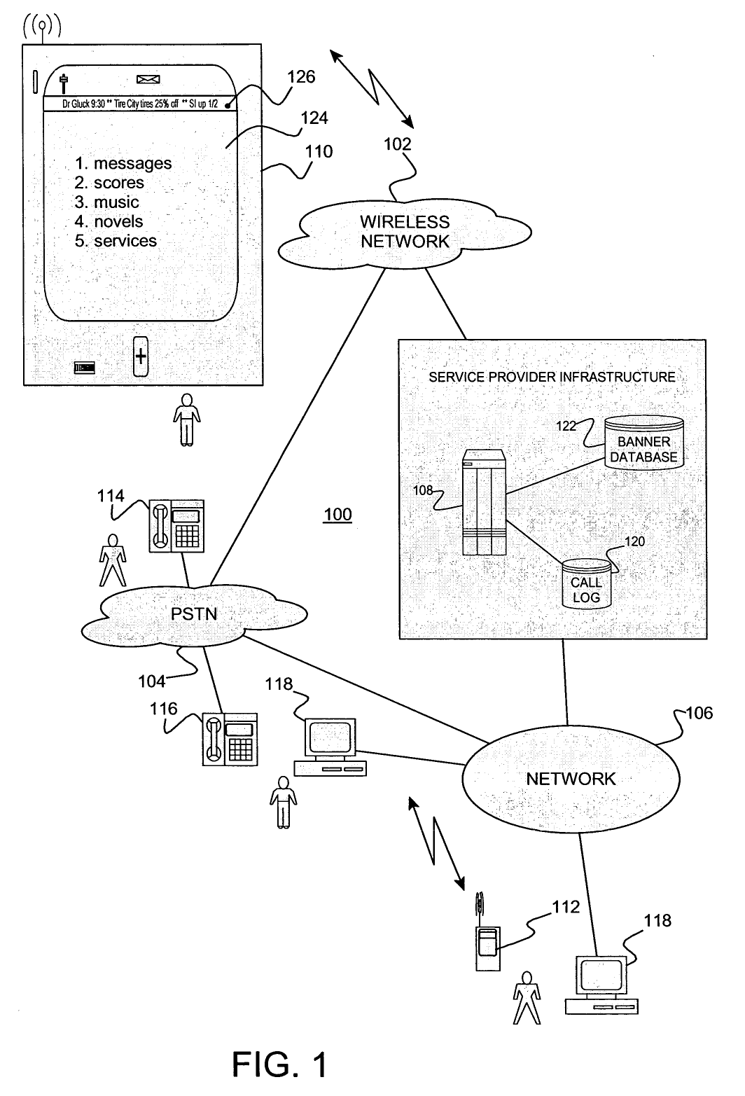

Turning now to the drawings and more particularly, FIG. 1 shows an example of a preferred embodiment communications service network 100 that provides personalized information to communications devices for subscribers and individually tailored to the particular subscriber. As used herein and unless specifically set forth otherwise, service subscribers or subscribers refers not only to communications service subscribers, but also to public and private concerns providing content for inclusion with personalized information provided to communications service subscribers.

Subscribers, whether private users or business concerns, can connect wirelessly over a wireless network 102 or from a public switched telephone network (PSTN) 104. The wireless network 102 and PSTN 104 may be directly or indirectly connected to a data network 106 and, in this example, a server 108 in service provider infrastructure that includes service databases employed for personalizing and enhancing subscriber communications. Since service information is freely exchanged between the wireless network 102, PSTN 104 and data network 106, the preferred service provider may be providing a single service or a wide range of services. For example, the preferred service provider may be, simply, a wireless service provider, a landline telephone company or an Internet service provider (ISP)). Alternately, the preferred service provider may be a wireless network service provider providing land based and Internet based services; a wired service provider (e.g., cable or landline phone) providing Internet and wireless access; an ISP providing wireless and wired communications capability; or any suitable equivalent or combination thereof. Users communicate using typical state of the art communications devices 110, 112, 114, 116 and 118. Subscriber information is maintained in databases in the server 108 that may include a call log 120 and a content database 122.

Wireless devices 110, 112, e.g., cell phones, each may include a display 124 and wirelessly connect over the wireless network 102. Typical wireless devices may include for example, a wireless capable personal digital assistant (PDA) 110 or an Internet capable cell phone 112. Further, wireless capability may include, for example, wireless LAN (WLAN) or Wi-Fi connections such as an IEEE 802.11a or 802.11b adapter, cell phone capability or Bluetooth. Digital and/or analog devices, e.g., digital or analog telephones 114, 116, connect over the PSTN 104. Digital devices 118 are connected to the service provider infrastructure over the data network 106 and may include any number of suitable general purpose stand alone computers, such as, for example, desktop computers, notebook computers, tablet computers and the like. Communications devices 110, 112, 114, 116, 118 are Internet capable, e.g., include a web portal capability 124, and banner capable including a capability of locally displaying a banner 126, e.g., a ticker applet for displaying individually tailored personal communications and other selected user information. Banners 126 may be displayed on the subscriber device in a personal portal 124 in a round robin fashion. Additionally, banners may be displayed, for example, in soft clients used to make calls, send and receive instant messages (IMs), or initiate conferences.

The call log 120 may indicate, for example, if a number for a subscriber was recently dialed or, if a call to a business subscriber's device is currently active. For each particular subscriber, the call log 120 might list active calls as well as call history, e.g., the last n calls made by the subscriber. The banner content database 122 includes banner information associated with subscribers including, for example, stock quote selection, personal service appointments, advertisement subscriptions, permissions allowing third parties to include advertisement and etc. The banner information is associated and provided, for example, to devices associated with listed phone numbers for local display in personally tailored banners. Also, information in the banner content database 122 is used to identify and match legitimate subscribers, business subscribers and etc. Since some communications service subscribers may not have subscribed to specific advertisement services or may have specifically placed privacy restrictions on their services; banner information may be selectively provided/applied to those devices not subject to privacy restrictions and associated with a subscribing called number.

Prior incoming communications to a business owner may be tagged and, subsequently, provided banner information from the business subscriber owner, e.g., for a business ad banner. The server 108 identifies and provides banner content for display on any selected subscriber device with a suitable display capability 124 and in communications with a networked device 110, 112, 114, 116 or 118. Users may have previously selected specific banner content (in content database 122), which is associated with corresponding communicating devices 110, 112, 114, 116, 118 for display by the particular device. A subscribing company or business subscriber, for example, may wish to advertise specials, sales, clearance items and etc. to existing customers, e.g., as identified by data from logged calls in the call log 120. Advertisement data in the banner content database 122, for example, may include additional attributes such as content expiration, duration of display and if the content is to be applied to the called or calling (subscriber) number.

So, for example, an individual subscriber associated with device 110 may select receiving stock ticker data. Another individual subscriber associated with device 112 may select receiving news flashes and news updates. A business subscriber, a dental office at device 114, for example, may choose to have patients provided with hours of operation, an off hours contact and, selectively, include scheduled patient appointments. Also, retail business subscriber at device 116 can select individualized advertisement banners/information for display at those of communicating devices 110, 112, 114, 116, 118 that are identified with current customers. Each call to and/or from the dental office 114 or the retail business subscriber at device 116 is logged. Thereafter, each caller may be presented with a personalized banner, e.g., 126, displayed on an available local Internet portal 124 that indicates a reminder (e.g., for a dental appointment) with dental office hours and emergency contact information, advertisements (e.g., current specials for the business subscriber) and stock ticker data.

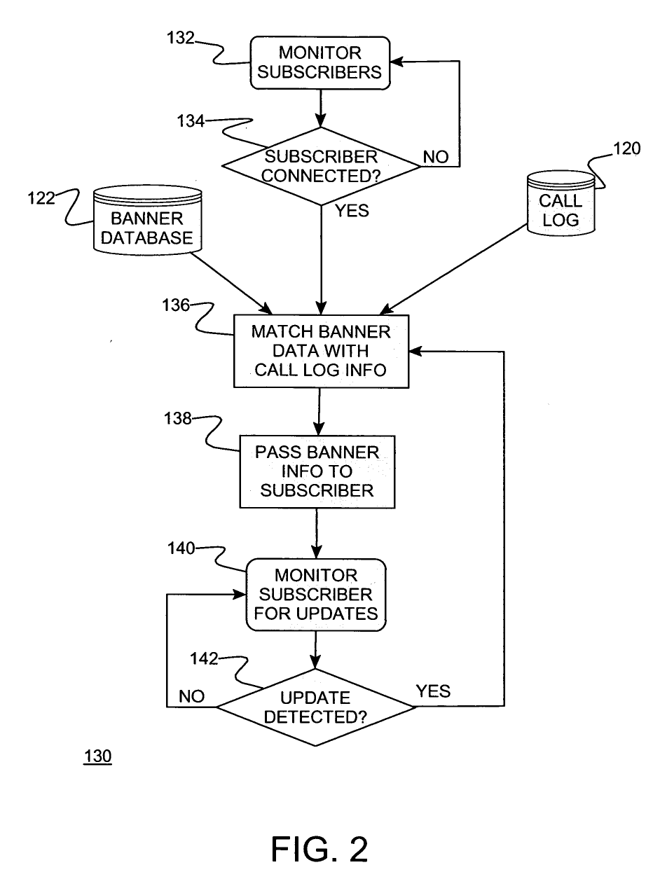

FIG. 2 shows a flow diagram example 130 of a preferred embodiment system wherein personalized information is individually tailored and distributed to communications devices (e.g., 110, 112, 114, 116 and 118 in FIG. 1) for service subscribers. Devices identified to service subscribers and that are not currently actively connected to the service are monitored in step 132 and checked in step 134 until one of the monitored devices connects to the service. When a subscriber device connects in step 134 information is retrieved from the call log 120 and updated, if warranted, e.g., a first time caller to a business subscriber. In step 136 the information from the call log 120 is matched with banner data retrieved from the banner database 122. In step 138 the matching banner data is passed to the subscriber device for display in a local banner 126, e.g., by a local banner applet. Thereafter, in step 140 data for the subscriber, e.g., the call log 120 and banner database 122 are monitored. In step 142 if an update is detected, the banner data is updated in step 136 and passed for display in 138. Otherwise, if no updates are detected in step 142, monitoring continues in step 140.

Subscribers may be charged, for example, based on the frequency with which the banner data is fetched from the banner database 122. Also, communications service subscribers may receive discounts for allowing ads with the originating business subscriber being charged for each subscriber receiving the ads, the frequency of receipt, ad length and etc. Similarly, specific banner data might also be included and displayed in an on demand manner, e.g., only when the subscriber/user calls a specific number identified in the banner database 122.

Advantageously, system subscribers are each provided with banner information that may be unique and is personally tailored to the particular subscriber. A business subscriber can advertise to targeted individual customers with ads provided to users over Internet portals, thereby reducing call center traffic but still allowing those subscribers receiving the ads to place calls, e.g., to the company's call center. Thus, service providers can distribute tightly tailored information to individuals efficiently informing individual subscribers of relevant information and, for example, providing businesses with a low overhead highly focused advertisement capability for addressing narrow market segments.

While the invention has been described in terms of preferred embodiments, those skilled in the art will recognize that the invention can be practiced with modification within the spirit and scope of the appended claims.

What is claimed is:

1. A communications system comprising:
a plurality of communications devices identified with corresponding system subscribers;
a service provider infrastructure monitoring communications with said plurality of communications devices; and
ones of said plurality of communications devices including a local display and receiving information for an associated system subscriber from said service provider infrastructure, received said information being displayed on said local display.

2. A communications network as in claim 1, wherein said service provider infrastructure comprises:
call log storage storing system subscriber call history; and
content storage storing banner data associated with system subscribers, said banner data for said associated system subscriber being said information provided for display at said local display.

3. A communications network as in claim 2, wherein said service provider infrastructure further comprises a server, said call log storage and said content storage being maintained by said server, said server selecting said banner data from said content storage responsive to said system subscriber call history in said call log storage.

4. A communications network as in claim 1, wherein said ones stream said information in a banner on said local display.

5. A communications network as in claim 1, further comprising a wireless network and said ones include a plurality of wireless communications devices communicating over said wireless network.

6. A communications network as in claim 5, wherein said wireless network is a cell phone network.

7. A communications network as in claim 6, wherein said service provider infrastructure comprises a server maintaining call log storage and content storage, said server selecting banner data from said content storage responsive to system subscriber call history in said call log storage, system subscriber associated cell phones streaming associated said banner data in a banner on associated local cell phone displays.

8. A service provider infrastructure for a communications system with a plurality of communications devices identified with corresponding system subscribers, said service provider infrastructure comprising:
means for monitoring communications with said plurality of communications devices;
call logging means for storing system subscriber call history; and
content storage means for storing banner data associated with system subscribers, said banner data for said associated system subscriber being said information provided for display, wherein ones of said plurality of communications devices with a local display receive said banner data for said associated system subscriber and display said received banner data on said local display.

9. A service provider infrastructure as in claim 8, wherein said service provider infrastructure further comprises a server, said call logging means and said content storage means being maintained by said server, said server selecting said banner data from said content storage responsive to said system subscriber call history in said call log storage.

10. A service provider infrastructure as in claim 8, wherein ones of said ones of said plurality of communications devices with a local display include a banner capability and said service provider infrastructure provides said banner data for streaming on said local display in a banner.

11. A service provider infrastructure as in claim 8, wherein said service provider infrastructure is a wireless communications service provider infrastructure and said ones of said plurality of communications devices with a local display include a plurality of wireless communications devices.

12. A service provider infrastructure as in claim 11, wherein said wireless communications service provider infrastructure is a cell phone service provider infrastructure.

13. A method of providing personalized information to communications devices in a communications network, said method comprising the steps of:
a) monitoring communications devices in a communications network for connection to said communications network;
b) selecting content information for each connecting communications device, said content information being associated with a system subscriber identified with said connecting communications device;
c) providing selected said content information to said connecting communications device; and
d) displaying said selected content information, displayed said content information being personalized information tailored to the identified said system subscriber.

14. A method of providing personalized information as in claim 13, wherein the step (b) of selecting said content information comprises:
i) retrieving call data related to connections with said connecting communications device;
ii) matching content in a content database to retrieved said call data; and
iii) retrieving matched content from said content database.

15. A method of providing personalized information as in claim 14, wherein said call data retrieved in the step (i) of retrieving said call data is retrieved from a call log.

16. A method of providing personalized information as in claim 15, wherein the step (i) of retrieving said call data further comprises updating said call log.

17. A method of providing personalized information as in claim 13, wherein the step (d) of displaying said selected content information comprises including said selected content information in a banner on a display on said connecting communications device.

18. A method of providing personalized information as in claim 17, said method further comprising the steps of:
e) monitoring communications devices displaying personalized information for content information updates; and
f) selectively updating stored content.

19. A method of providing personalized information as in claim 18, said method further comprising the steps of:
g) returning to step (b).

20. A method of providing personalized information as in claim 13, wherein business ads are displayed on connecting communications devices identified as being associated with system subscribers that have previously placed calls to a business subscriber.

21. A computer program product for providing personalized information to communications devices in a communications network, said computer program product comprising a computer usable medium having computer readable program code thereon, said computer readable program code comprising:
computer program code means for monitoring connection of communications devices in a communications network;
computer program code means for selecting content information for a system subscriber associated with a connecting communications device; and
computer program code means for providing selected said content information to said connecting communications device, said connecting communications device displaying personalized information tailored to said associated system subscriber.

22. A computer program product for providing personalized information as in claim 21, wherein said computer program code means for selecting said content information comprises:
computer program code means for logging call data related to said communications devices;
computer program code means for storing subscriber related content; and
computer program code means for matching said subscriber related content to logged said call data.

23. A computer program product for providing personalized information as in claim 22, wherein said computer program code means for selecting said content information comprises:
computer program code means for receiving updates for said subscriber related content.

24. A computer program product for providing personalized information as in claim 21, wherein said subscriber related content includes business advertisement data for display in banners on said connecting communications devices identified as being associated with system subscribers that have previously placed calls to a business subscriber.
